(19) United States
(12) Patent Application Publication
(10) Pub. No.: US 2024/0194159 A1
(43) Pub. Date: Jun. 13, 2024

(54) TRANSPARENT DISPLAY APPARATUS

(71) Applicant: Japan Display Inc., Tokyo (JP)

(72) Inventor: Keiji TAGO, Tokyo (JP)

(21) Appl. No.: 18/528,901

(22) Filed: Dec. 5, 2023

(30) Foreign Application Priority Data
Dec. 8, 2022 (JP) 2022-196587

(51) Int. Cl. G09G 3/36; G02F 1/1333; G02F 1/13357

(52) U.S. Cl. CPC G09G 3/3648; G02F 1/133342; G02F 1/13338; G02F 1/133615; G09G 2300/0478

(57) ABSTRACT

A transparent display includes: a first substrate having a first surface; a second substrate having a second surface; a display layer having pixels that can transition between a transparent state that transmits background light and a display state that displays an image; a display region (screen); a controller; and a sensor device (camera) for detecting a distance between a user on a first surface side and the display region, and a position in the display region. The controller controls a degree of transparency so as to be changed in a partial region corresponding to the position according to the distance from the user to the screen.

### CROSS-REFERENCE TO RELATED APPLICATION

The present application claims priority from Japanese Patent Application No. 2022-196587 filed on Dec. 8, 2022, the content of which is hereby incorporated by reference into this application.

### TECHNICAL FIELD

The present disclosure relates to a technique of a transparent display apparatus.

### BACKGROUND

In recent years, transparent displays (in other words, transparent display apparatuses) have been developed and provided. The transparent displays display images (in other words, video images, and the like) in a display region configured by a liquid crystal layer or the like and having light permeability. A person who is a user can visually recognize a display image on the transparent display from both a front surface and a back surface in a state of superimposing it on a background.

Japanese Patent Application laid-open No. 2022-92511 (Patent Document 1) discloses an example of a transparent display that realizes high transparency and transmittance.

### SUMMARY

An object of the present disclosure is to, regarding a technique of a transparent display, propose new using methods and the like and provide a technique capable of improving communication, convenience, and the like.

One aspect of the present invention is a transparent display apparatus including: a first substrate having a first surface; a second substrate having a second surface opposite to the first surface; a display layer arranged between the first substrate and the second substrate, and having pixels that can transition between a transparent state that transmits background light and a display state that displays an image; a display region provided in a region which the first substrate, the second substrate, and the display layer overlap; a controller controlling a state of the pixels of the display layer; the image from a side of the first surface and a background on a side of the second surface being capable of being visually recognized; and a sensor device for detecting a distance between a user on the first surface side in the display region and the display region, and a position corresponding to the distance in the display region, in which the controller uses detection information of the sensor device to control transition between the transparent state and the display state of the pixel in a partial region corresponding to the position according to the distance, thereby controlling switching of a degree of transparency.

One aspect of the present invention is a transparent display apparatus including: a first substrate having a first surface; a second substrate having a second surface opposite to the first surface; a display layer arranged between the first substrate and the second substrate, and having pixels that can transition between a transparent state that transmits background light and a display state that displays an image; a display region provided in a region which the first substrate, the second substrate, and the display layer overlap; a controller controlling a state of the pixels of the display layer; the image from a side of the first surface and a background on a side of the second surface being capable of visually recognized; and a sensor device for detecting a distance between a user on the first surface side in the display region and the display region, and a position corresponding to the distance in the display region, in which the controller uses detection information of the sensor device to control transition between the transparent state and the display state of the pixels according to the distance, thereby controlling the image so as to be added and displayed in a partial region corresponding to the position.

### DRAWINGS

FIG. 1 is a diagram showing a configuration of a system including a transparent display apparatus according to a first embodiment;

FIG. 2A is an explanatory diagram of basic characteristics of the transparent display apparatus according to the first embodiment;

FIG. 2B is an explanatory diagram of the basic characteristics of the transparent display apparatus according to the first embodiment;

FIG. 3 is a perspective view of a hardware configuration example of the transparent display apparatus according to the first embodiment;

FIG. 4 is a cross-sectional view of the transparent display apparatus according to the first embodiment;

FIG. 5 is a diagram showing a configuration example of circuits of the transparent display apparatus according to the first embodiment;

FIG. 6 is a diagram showing a configuration example of a controller in the transparent display apparatus according to the first embodiment;

FIG. 7 is a diagram showing a screen display example for transparentizing control in the transparent display apparatus according to the first embodiment;

FIG. 8A is a side view of the transparent display apparatus according to the first embodiment as an explanatory diagram of a distance and the like;

FIG. 8B is a top view of the transparent display apparatus according to the first embodiment as the explanatory diagram of the distance and the like;

FIG. 9 is a diagram showing a processing flow in the transparent display apparatus according to the first embodiment;

FIG. 10A is an explanatory diagram of transparency control in the transparent display apparatus according to the first embodiment;

FIG. 10B is an explanatory diagram of the transparency control in the transparent display apparatus according to the first embodiment;

FIG. 10C is an explanatory diagram of the transparency control in the transparent display apparatus according to the first embodiment;

FIG. 10D is an explanatory diagram of the transparency control in the transparent display apparatus according to the first embodiment;

FIG. 11A is an explanatory diagram of control of a transparent area in the transparent display apparatus according to the first embodiment;

FIG. 11B is an explanatory diagram of the control of the transparent area in the transparent display apparatus according to the first embodiment;

FIG. 11C is an explanatory diagram of the control of the transparent area in the transparent display apparatus according to the first embodiment;

FIG. 11D is an explanatory diagram of the control of the transparent area in the transparent display apparatus according to the first embodiment;

FIG. 12A is an explanatory diagram of control of transparency and a transparent area and control of following movement in the transparent display apparatus according to the first embodiment;

FIG. 12B is an explanatory diagram of the control of the transparency and the transparent area and the control of following the movement in the transparent display apparatus according to the first embodiment;

FIG. 13 is an explanatory diagram of control using a visual line in the transparent display apparatus according to the first embodiment;

FIG. 14 is a diagram showing a configuration of a system including a transparent display apparatus according to a second embodiment;

FIG. 15A is an explanatory diagram of control of additional image display in the transparent display apparatus according to the second embodiment;

FIG. 15B is an explanatory diagram of the control of the additional image display in the transparent display apparatus according to the second embodiment;

FIG. 16A is an explanatory diagram of control of a notification in the transparent display apparatus according to the second embodiment;

FIG. 16B is an explanatory diagram of the control of the notification in the transparent display apparatus according to the second embodiment;

FIG. 16C is an explanatory diagram of the control of the notification in the transparent display apparatus according to the second embodiment;

FIG. 17A is an explanatory diagram of multi-stage character size control in a transparent display apparatus according to a modification example of the second embodiment;

FIG. 17B is an explanatory diagram of the multi-stage character size control in the transparent display apparatus according to the modification example of the second embodiment;

FIG. 18A is a diagram showing a configuration of a system including a transparent display apparatus according to a third embodiment;

FIG. 18B is a diagram showing the configuration of the system including the transparent display apparatus according to the third embodiment; and

FIG. 19 is a diagram showing a configuration of a system including a transparent display apparatus according to a fourth embodiment.

### PREFERRED EMBODIMENTS

Hereinafter, embodiments of the present disclosure will be described in detail with reference to the drawings. In the drawings, the same parts are denoted by the same reference numerals in principle, and a repetitive description thereof will be omitted. In the drawings, in order to facilitate understanding of the invention, components may be schematically represented about a width, a thickness, a shape, and the like of each part in comparison with the actual aspect, but this is merely one example and it is not intended to limit the interpretation of the present invention.

For the purpose of explanation, when explaining processings by programs, the programs, functions, processing units, and the like may be explained as a main body, but the main body of hardware for these is a processor or is a controller configured by the processor and the like, a device, a calculator, a system, and the like. The calculator executes the processing according to a program read onto a memory by the processor while appropriately using resources such as a memory and a communication interface. This realizes predetermined functions, processing units, and the like. The processor is configured by, for example, a semiconductor device such as a CPU/MPU or a GPU. The processing is not limited to software program processing, and can also be implemented by using a dedicated circuit. As the dedicated circuit, FPGA, ASIC, CPLD, and the like can be applied.

A program(s) may be installed in advance as data on a target calculator, or may be distributed as data from a program source to the target calculator. The program source may be a program distribution server on a communication network or be a non-transitory computer-readable storage medium such as a memory card or a disk. A program may be configured by multiple modules. A computer system may be configured by multiple devices. The computer system may be configured by a client/server system, a cloud computing system, an IoT system, and the like. Various types of pieces of data and information are configured with, for example, a structure such as a table or a list, but are not limited thereto. Expressions such as identification information, identifier, ID, name, and number can be replaced with each other.

### First Embodiment

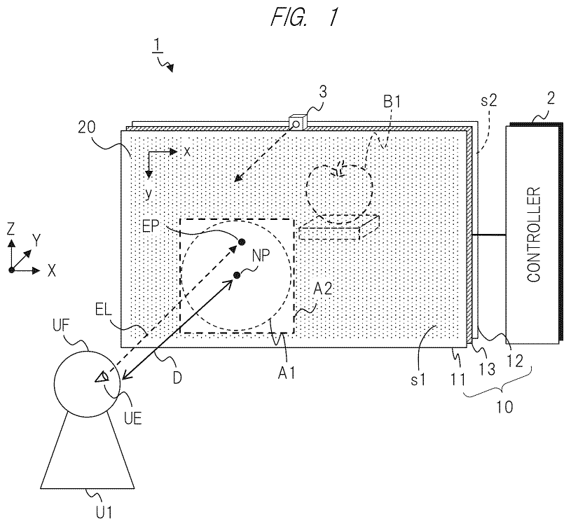

A transparent display apparatus according to a first embodiment will be explained by using FIGS. 1 to 13. The transparent display apparatus according to the first embodiment is a transparent display 1 shown in FIG. 1 and the like. This transparent display 1 displays an image on a screen 20 (display region corresponding thereto) having light permeability. When a user U1 approaches the screen 20, the transparent display 1 makes a partial region A2 corresponding to a location A1 transparent according to an approaching distance D and the approaching location A1. That is, the transparent display 1 changes the region A2 from a display state of displaying an image to a transparent state of making the background transparent. This makes it easier for the user U1 to visually recognize an object B1 and the like in the background via the approaching location A1.

The transparent display 1 can switch at least between the above-mentioned display state and transparent state for each pixel of the screen 20. In other words, the transparent display 1 can switch as control for transparentizing between the display state that is an OFF state of the transparentizing and the transparent state that is an ON state of the transparentizing. The display state is a state in which the image displayed on the screen 20 is more easily visually recognized than the background, and the transparent state is a state in which the background is more easily visually recognized than the image displayed on the screen 20.

In addition, the transparent display 1 can set a degree of transparency (sometimes referred to as transparency) between the display state and the transparent state for each pixel of the screen 20 by being changed not only in a binary state of on/off but also in a multi-valued manner. Further, the transparent display 1 can also change an area and the like of a region A2 of the pixel in controlling on/off-state of the transparentizing or the transparency. For example, the transparent display 1 is controlled so that as the distance D when the user U1 approaches the screen 20 is closer, the transparency of the region A2 corresponding to an approaching position NP is higher and the area is larger.

In the first embodiment, a case of a liquid crystal display device having a liquid crystal layer as a display layer 13 of the transparent display 1 will be described. In the first embodiment, a transparent display panel that is a main body 10 configuring the transparent display 1 realizes a transmittance of 84%, which is almost the same as that of a window glass, as transmittance indicating the degree of transparency of the display region of the screen 20, and a case of using the transparent display panel will be described.

The transparent display 1 according to the first embodiment can be installed and used at any position. The transparent display 1 according to the first embodiment can be installed, for example, at a counter or window at which a person faces another person, a partition between a person and another person, a show window glass such as a store, and the like.

### [Transparent Display]

FIG. 1 shows a configuration of a system including the transparent display 1 which is a transparent display apparatus according to the first embodiment. The system of FIG. 1 has a transparent display 1. The transparent display 1 includes a transparent display panel which is a main body 10, a controller 2 connected to or built into the main body 10, and a camera 3 installed in the main body 10. FIG. 1 shows a case of having a user U1 visually recognizing the screen 20 of the transparent display 1 from a first surface s1 side that is a front surface, and an object B1 (in other words, a background object) placed on a second surface s2 side that is a back surface. FIG. 1 schematically shows, as a perspective view, the screen 20 and the like of the main body 10 of the transparent display 1.

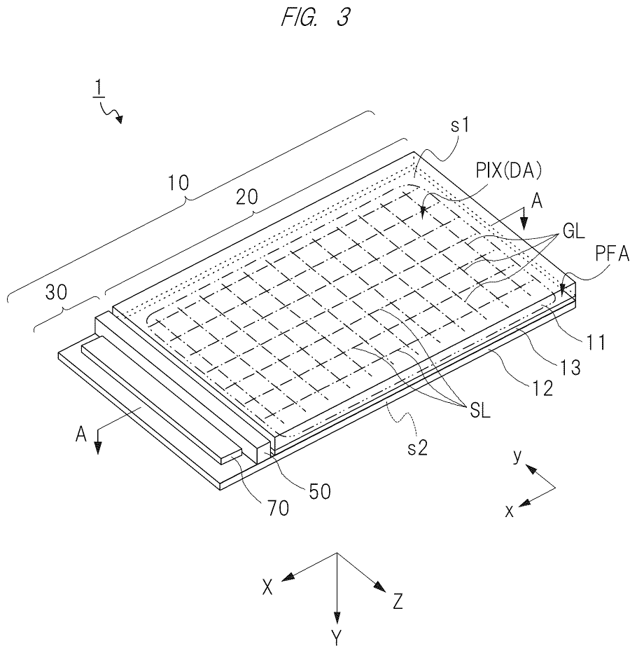

The transparent display 1 has the main body 10 (in other words, the transparent display panel) including a first substrate 11, a second substrate 12, and a display layer 13, which configure the screen 20. The controller 2 is electrically connected to the main body 10. In the first embodiment, the display layer 13 is a liquid crystal layer. The display layer 13 has a plurality of pixels forming a display region corresponding to the screen 20 (see FIG. 3 and the like described later).

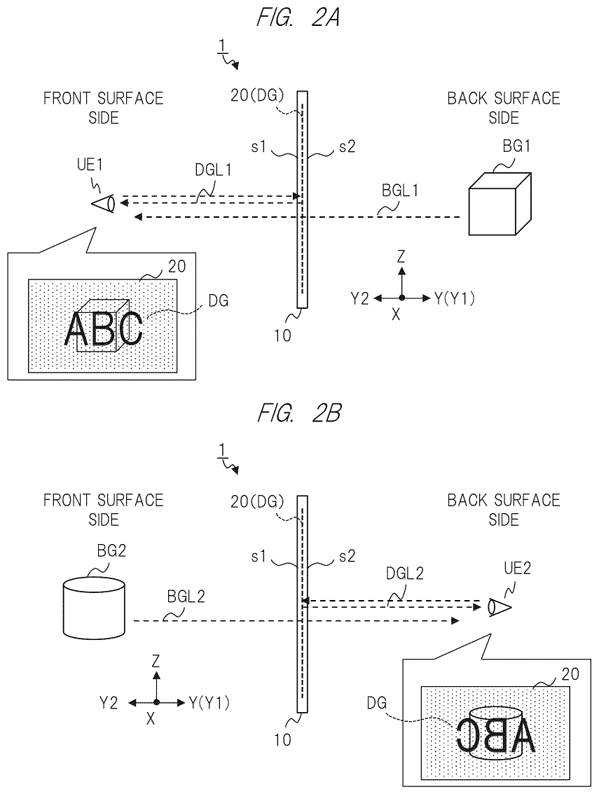

The main body 10 and the screen 20 have a first surface s1 on a first substrate 11 side, and a second surface s2 on a second substrate s2 side. For the purpose of explanation, the first surface s1 is assumed to be a front surface (in other words, a front), and the second surface s2 is assumed to be a back surface (in other words, a back). By controlling the display layer 13, the transparent display 1 can display a video image toward a person on the first surface s1 side, and can also display a video image toward the person on the second surface s2 side. When the transparent display 1 displays an image/video image on the screen 20 according to control of the display layer 13, the display image can also be visually recognized from the person on the first surface s1 side and from the person on the second surface s2 side (FIGS. 2A and 2B described later).

An example of FIG. 1 shows a state on which the user U1 is approaching the first surface s1 side which is the front surface of the screen 20 of the transparent display 1, and the user U1 in front of the first surface s1 can visually recognize not only the display image on the screen 20 but also the background on the second surface s2. In FIG. 1, the display image on the screen 20 is schematically illustrated as dot patterns. Further, in the example of FIG. 1, an apple is placed as an example of the object B1 of the background on the second surface s2 side, and is schematically illustrated as a broken line. If the person on the second surface s2 side is present, the person can visually recognize not only the display image on the screen 20 but also the background on the first surface s1 side.

The controller 2 displays the images and video images on the screen 20 by controlling a display state of the pixels of the liquid crystal layer which is the display layer 13. The controller 2 controls gradation and the degree of transparency between the display state and the transparent state as a state of each pixel. The controller 2 may be built into the main body 10 or may be connected to an outside of the main body 10. For example, control circuits configuring the controller 2 may be mounted on a portion of the first substrate 11 or the second substrate 12 in addition to a drive circuit or the like. The controller 2 may be a device such as a PC external to the main body 10. In addition, although not shown, a microphone, a speaker, a lamp, and the like may be installed and connected to the main body 10.

The camera 3 is a type of sensor device installed in the main body 10. The camera 3 photographs a front direction with respect to the first surface s1 which is the front surface of the screen 20, and detects approach of the person. The camera 3 uses a CCD camera or the like in this example, but is not limited to this and may be any sensor device that can detect the approach of the person, the distance to the person, the position, and the like. The camera 3 may be a stereo camera, a ranging sensor, an infrared sensor, LiDAR (Light Detection and Ranging, Laser Imaging Detection and Ranging), or the like. Further, in this example, the camera 3 transmits the photographed image to the controller 2, and the controller 2 performs an image processing based on the photographed image (in other words, a camera image), thereby detecting the approach of the user U1 to the screen 20, the distance D between the screen 20 and the approaching user U1, and the like. The camera 3 is not limited thereto, and may be a module including a processor, a circuit, and the like that performs such a detection processing.

Further, in a case of using visual line detection described below, the camera 3 may be an eye-tracking device.

In FIG. 1, the distance between the user U1 and the screen 20 is indicated by D. In particular, the distance between a face (or head) of the user U1 and the position NP (in other words, a point, a pixel) within the screen 20 is D. Furthermore, as will be described later, the visual line of the user U1 may be detected and utilized. In that case, the visual line from the eyes UE of the user U1 is indicated by EL, and a gaze point in the screen 20 beyond the visual line EL is indicated by EP.

In FIG. 1, when the user U1 approaches the screen 20, the approaching location of the user U1 is roughly indicated by a location A1 shaped like a broken line circle. The location A1 is a circle centered on a position NP at the distance D. In addition, a pixel region for control and the partial region are shown as a region A2 shaped like a rectangular so as to correspond to the approaching location A1. The region A2 is a rectangle centered on the position NP at the distance D. The region A2 is a region to be controlled for the transparentizing which will be described later. Although the region A2 is illustrated as a case of having a square shape, the region A2 is not limited to this and may have any shape.

For the sake of explanation, (X, Y, Z) and (x, y) shown in the figures may be used as coordinate systems and directions. An X axis/X direction and a Y axis/Y direction in FIG. 1 are two horizontal directions orthogonal to each other, and a Z axis/Z direction is a vertical direction. The X direction is a right and left direction as seen from the user U1, the Z direction is an up and down direction as seen from the user U1, and the Y direction is a front and rear direction as seen from the user U1. Further, the x direction in FIG. 1 is a horizontal direction (in-screen horizontal direction) that configures the screen 20, and the y direction is a vertical direction (in-screen vertical direction) that configures the screen 20.

The transparent display 1 in FIG. 1, particularly, the controller 2, may be connected to an external device(s) via a predetermined communication interface such as an HDMI interface. The transparent display 1 may receive and input a video image signal from, for example, a video image source device as the external device, and display it on the screen 20. The transparent display 1 in that case functions as a monitor display.

### [Basic Characteristics of Transparent Display]

Basic characteristics of the transparent display 1 according to the first embodiment will be explained by using FIGS. 2A and 2B. The transparent display 1 allows the person to visually recognize the video image displayed on the screen 20 in FIG. 1 and a display image DG in FIGS. 2A and 2B not only from the first surface s1 side on which the person is the front surface but also from the second surface s2 side which is the back surface.

The transparent display 1 has characteristics of visually recognizing, from the person on the first surface s1 side, the display image and the background on the second surface s2 side on the screen 20 and, from the person on the second surface s2 side, the display image and the background on the second surface s2 side on the screen 20. In the display region that is the screen 20, when the image is displayed toward the person on the first surface s1 side, the image can also be visually recognized by the person on the second surface s2 side. However, the image at that time is a content and a state seen from the back surface side, and is different from a content and a state seen from the front surface side.

FIGS. 2A and 2B are a schematically explanatory diagrams of the transparent display 1 viewed from a side. FIG. 2A shows a case where the person is present on a front side (direction Y2) with respect to the front surface that is the first surface s1 of the transparent display 1 and the display image DG on the screen 20 is visually recognized from a viewpoint UE1 of the person. FIG. 2B shows, on the contrary, a case where the person is present on a front side (direction Y1) with respect to the back surface which is the second surface s2 on an opposite side to the first surface s1 of the transparent display 1 and the display image DG on the screen 20 is visually recognized from a viewpoint UE2 of the person.

In FIG. 2A, a person who is a first observer views, from the viewpoint UE1, the screen 20 of the main body 10 of the transparent display 1 in a direction from the one first surface s1 side to the other second surface s2 side (direction Y1). In this case, the first observer can visually recognize not only the display image DG on the screen 20, for example, a character “ABC” image and image light DGL1 corresponding thereto but also an object BG1 of the background on the second surface s2 side and background light BGL1 corresponding thereto by being transmitted to the first surface s1 side.

In FIG. 2B, a person who is a second observer views, from the viewpoint UE2, the screen 20 of the main body 10 of the transparent display 1 in a direction from the second surface s2 side to the first surface s1 side (direction Y2). In this case, the second observer can visually recognize not only the display image DG and image light DGL2 corresponding thereto but also an object BG2 of the background on the first surface s1 side and background light BGL2 corresponding thereto by being transmitted to the second surface s2 side.

The first surface s1 and the second surface s2 of the main body 10, and the display region which configure at least the screen 20 have the above-mentioned characteristics, in other words, background transparency and the like. A peripheral region (see FIG. 3 described later) other than the display region in the first surface s1 and the second surface s2 of the main body 10 may be configured to have the same characteristics as those described above, or may be configured to have light-shielding characteristics that does not transmit the background.

Note that, as in examples of FIGS. 2A and 2B, the display image DG displayed on the screen 20 is displayed as an image having a state of pointing to either the front surface side or the back surface side. For example, as shown in FIG. 2A, a character image “ABC” directed toward the person (first observer) on the first surface s1 side is displayed. In this case, when the same character image is visually recognized from the person on the second surface s2 side (second observer) as shown in FIG. 2B, the characters “ABC” appears as a reversed image in the right and left direction.

### Hardware Configuration Example of Transparent Display

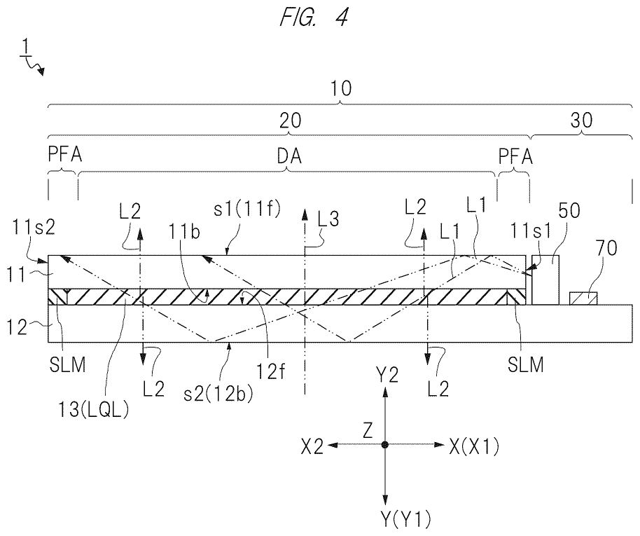

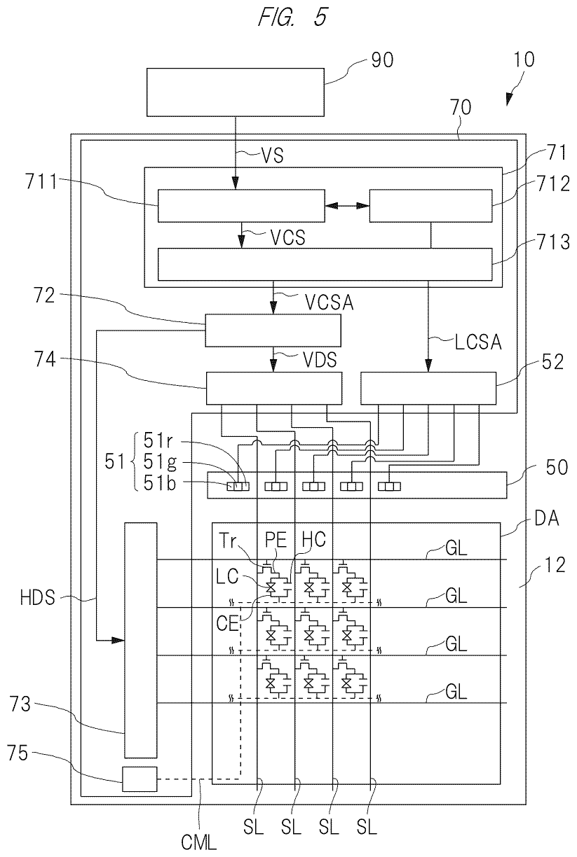

An example of a hardware configuration example of the transparent display 1 according to the first embodiment will be explained by using FIGS. 3 to 5. FIG. 3 is a perspective view showing an outline of a configuration example of the main body 10 of the transparent display 1. FIG. 4 is a cross-sectional view taken along line A-A in FIG. 3, and also schematically shows a path and the like of light emitted from a light source unit 50 of the transparent display 1. FIG. 5 shows a configuration example of a circuit formed in the main body 10.

FIG. 3 shows a perspective view of the transparent display panel which is the main body 10, the perspective view mainly looking at the first surface s1. The transparent display panel that is the main body 10 has the first substrate 11, the second substrate 12, the display layer 13, the light source unit 50, and a drive circuit 70. In the Y direction which is the front and back direction, the first substrate 11, the display layer 13, and the second substrate 12 are arranged from the first surface s1 side which is the front surface.

This transparent display panel that is the main body 10 is a liquid crystal display panel. The first substrate 11 is an opposite substrate, the second substrate 12 is an array substrate, and the display layer 13 is the liquid crystal layer. Pixels PIX of the display layer 13 of the screen 20 emit light in all directions.

In FIG. 3, according to a coordinate system of FIG. 1, a direction along a thickness direction of the transparent display panel that is the main body 10 is defined as a Y direction, an extension direction of one side of the transparent display panel is defined as an X direction in an X-Z plane orthogonal to the Y direction, and a direction intersecting with the X direction is defined as a Z direction. Furthermore, as for a coordinate system (x, y) in the screen 20, an x direction corresponding to the X direction is a horizontal direction (in-screen horizontal direction), and a y direction corresponding to the Z direction is a vertical direction (in-screen vertical direction). In this example, the screen 20 is a horizontally long screen in which a size in the X direction (x direction) is larger than a size in the Z direction (y direction), but the screen 20 is not limited to this.

The first surface s1 has a display region DA corresponding to the screen 20, and a peripheral region PFA. Note that in this example, the peripheral region PFA is also a part of the screen 20. The display region DA configuring the screen 20 is located in a region where the first substrate 11, the second substrate 12, and the display layer 13 overlap when viewed in a plan view in the Y direction. The peripheral region PFA is outside the display region DA. A boundary between the display region DA and the peripheral region PFA is indicated by a dash-double-dot line.

The display region DA is a region where the images and the video images are formed according to input signals supplied from the outside. The display region DA is an effective region where the image/video image is displayed when viewed in a plan view, for example, when viewing the first surface s1 or viewing the second surface s2 in the Y direction. A plurality of pixels PIX are formed in a matrix on the display layer 13 corresponding to the display region DA.

The peripheral region PFA is a region including four sides around the display region DA, in other words, a frame region, and no image/video image is displayed.

As shown in FIG. 3, in this example, the second substrate 12 has a larger width in the X direction than the first substrate 11. The second substrate 12 has a region 30 extending on one side in the X direction on the first surface s1 side, in this example, has a right-side region. The light source unit 50 and the drive circuit 70 are mounted in the region 30.

The light source unit 50 (in other words, a light source device) is arranged along the peripheral region PFA on the right side with respect to the screen 20. The light source unit 50 generates light source light for liquid crystal display on the display layer 13, and supplies it to the display layer 13.

The drive circuit 70 generates electric signals for driving the first substrate 11, the second substrate 12, the display layer 13, and the light source unit 50, and supplies them to each of these parts. In FIG. 3, a part of signal wirings, which transmits signals for driving the liquid crystal corresponding to the pixel PIX, among the circuits included in the transparent display panel, specifically, a gate line GL and a source line SL, which will be described later, are schematically shown by dash-single-dot lines.

Besides components shown in FIG. 3, this transparent display panel may also include, for example, a control circuit, a flexible printed circuit board, a casing, and the like. A part of the drive circuit may be implemented in the peripheral region PFA. For example, as the casing, members that fixes the first substrate 11, the display layer 13, and the second substrate 12 are raised. In FIG. 3, those elements are omitted. In addition, although the display region DA is a quadrangle in this example, it is not limited to this and may have other shapes such as a polygon or a circle. Further, in this example, the light source unit 50 and the drive circuit 70 are mounted in the region 30, but the present embodiment is not limited to this. As a modification example, a light source substrate and a drive circuit substrate (not shown) are attached to the peripheral region PFA separately from the first substrate 11 and the second substrate 12, and a configuration in which the light source unit 50 is mounted on the light source substrate, a configuration in which the drive circuit 70 is mounted on the drive circuit substrate, and the like are also possible.

In the X-Y cross-sectional view of FIG. 4, an optical path of light emitted from the light source unit 50, a state of the liquid crystal, and the like in the transparent display panel that is the main body 10 will be explained. The transparent display panel that is the main body 10 has, as the display layer 13, the first substrate 11 and the second substrate 12 that are bonded together so as to oppose each other via the liquid crystal layer LQL. The first substrate 11 and the second substrate 12 are arranged in the Y direction, which is the thickness direction of the transparent display panel, via the liquid crystal layer LQL. In other words, the first substrate 11 and the second substrate 12 oppose each other in the Y direction which is the thickness direction of the transparent display panel.

The array substrate, which is the second substrate 12, has the front surface 12f opposing the liquid crystal layer LQL and the first substrate 11. The opposite substrate, which is the first substrate 11, has a front surface 12f of the second substrate 12 and a back surface 11b opposing the liquid crystal layer LQL. The liquid crystal layer LQL containing liquid crystal is located between the front surface 12f of the second substrate 12 and the back surface 11b of the first substrate 11. In other words, the liquid crystal layer LQL is an optical modulation element.

The second substrate 12 is the array substrate in which a plurality of transistors (in other words, transistor elements) as switching elements (in other words, active elements) described later are arranged in an array. The first substrate 11 means a substrate placed opposite to the array substrate that is the second substrate 12, and can restate an opposite substrate in different words.

The transparent display panel that is the main body 10 has a function of modulating light passing through the liquid crystal of the liquid crystal layer LQL by controlling a state of an electric field formed around the liquid crystal layer LQL via the switching element. The display region DA is provided in a region overlapping with the liquid crystal layer LQL.

The first substrate 11 and the second substrate 12 are bonded together via a sealing portion (in other words, a sealing material) SLM. The sealing portion SLM is arranged so as to surround the display region DA. Th liquid crystal layer LQL is present inside the sealing portion SLM. The sealing portion SLM plays a role of sealing the liquid crystal between the first substrate 11 and the second substrate 12 and a role of an adhesive for bonding the first substrate 11 and the second substrate 12 together.

The light source unit 50 is arranged at a position opposing one side surface 11s1 of the first substrate 11. Light source light L1, which is the light emitted from the light source unit 50, is schematically shown by a dash-double-dot line. The light source light L1 emitted from the light source unit 50 in the X direction propagates a direction away from the side surface 11s1 while reflected by the second surface s2 which is the back surface 12b of the second substrate 12 and the first surface s1 which is the front surface 11f of the first substrate 11, in this example, a direction X2, as shown in the figure. In a propagation path of the light source light L1, the back surface 12b of the second substrate 12 and the front surface 11f of the first substrate 11 are interfaces between a medium with a large refractive index and a medium with a small refractive index. Therefore, when an incident angle at which the light source light L1 enters the front surface 11f and the back surface 12b is larger than a critical angle, the light source light L1 is totally reflected on the front surface 11f and the back surface 12b.

The liquid crystal of the liquid crystal layer LQL is a polymer dispersed liquid crystal, and contains a liquid crystal polymer and liquid crystal molecules. The liquid crystalline polymer is formed into stripes, and the liquid crystal molecules are dispersed in gaps between the liquid crystalline polymers. Each of the liquid crystalline polymer and liquid crystal molecules has optical anisotropy or refractive index anisotropy. Responsiveness of the liquid crystalline polymer to electric fields is lower than responsiveness of liquid crystal molecules to electric fields. An orientation direction of the liquid crystalline polymer hardly changes regardless of presence or absence of the electric field.

Meanwhile, an orientation direction of liquid crystal molecules changes depending on the electric field when a high voltage equal to or higher than a threshold value is applied to the liquid crystal. When no voltage is applied to the liquid crystal, optical axes of the liquid crystal polymer and liquid crystal molecules are parallel to each other and the light source light L1 incident on the liquid crystal layer LQL is hardly scattered within the liquid crystal layer LQL and penetrates. Such a state may be referred to as a transparent state.

When a voltage is applied to the liquid crystal, the optical axes of the liquid crystal polymer and liquid crystal molecules intersect with each other and the light source light L1 incident on the liquid crystal is scattered within the liquid crystal layer LQL. Such a state may be referred to as a scattering state (in other words, a display state).

The transparent display panel that is the main body 10, specifically, the control circuit and the drive circuit 70 controls the transparent state and the scattering state (in other words, the display state) by controlling the orientation of the liquid crystal in the propagation path of the light source light L1. In the scattering state, the light source light L1 is emitted, as emission light L2 by the liquid crystal, to the outside of the transparent display panel from the first surface s1 side which is the front surface 11f, and the second surface s2 side which is the back surface 12b. This emission light L2 corresponds to display image light.

Further, background light L3 incident from the second surface s2 side, which is the back surface 12b, passes through the second substrate 12, the liquid crystal layer LQL, and the first substrate 11, and is emitted to the outside from the first surface s1 which is the front surface 11f.

These emission light L2 and background light L3 are visually recognized from the viewpoint UE1 of the first observer present on the first surface s1 side which is the front surface, as shown in FIG. 2A described above. The emission light L2 corresponds to image light DGL1, and the background light L3 corresponds to background light BGL1. The first observer can visually recognize the emission light L2 and the background light L3 in combination. In other words, the first observer can visually recognize a state in which the emission light L2 is superimposed on the background light L3. In this way, this transparent display panel is a display panel having characteristics that allows the observer to visually recognize the display image and the background as being superimposed.

In a case of the transparent display panel shown in FIG. 4, in order to ensure visible light permeability of the first surface s1 which is the front surface and the second surface s2 which is the back surface, the transparent display panel has a configuration in which the light source is located at a position not overlapping with the display region DA in a plan view. Further, this transparent display panel reflects the light source light L1 by utilizing a difference in refractive index between the first substrate 11 and second substrate 12, which function as light guide members, and a surrounding air layer. Consequently, this transparent display panel has a mechanism for delivering the light to the opposite side surface 11s2 opposing the light source unit 50.

With reference to FIG. 5, a configuration example of circuits included in the transparent display panel that is the main body 10 will be described. FIG. 5 shows a configuration example of the drive circuit 70, the light source unit 50, and the pixels PIX (FIG. 3) in the display region DA. A control unit 90 including a control circuit that controls the display of the images is connected to the drive circuit 70. This control unit 90 corresponds to the controller 2 in FIG. 1. However, the present embodiment is not limited to this, and the control unit 90 may be mounted on the transparent display panel together with the drive circuit 70.

The drive circuit 70 includes a signal processing circuit 71, a pixel control circuit 72, a gate drive circuit 73, a source drive circuit 74, a common potential drive circuit 75, and a light source control unit 52. Further, the light source unit 50 includes, for example, a light emitting diode element 51r (for example, red), a light emitting diode element 51g (for example, green), and a light emitting diode element 51b (for example, blue).

The signal processing circuit 71 includes an input signal analysis unit 711, a storage unit 712, and a signal adjustment unit 713. An input signal VS is inputted to the input signal analysis unit 711 of the signal processing circuit 71 from the control unit 90 via a wiring path such as a flexible printed circuit board (not shown). The input signal analysis unit 711 performs an analysis processing based on the inputted input signal VS and generates an input signal VCS. The input signal VCS is, for example, a signal determining what kind of gradation value is given to each pixel PIX (FIG. 3) based on the input signal VS.

The signal adjustment unit 713 generates an input signal VCSA from the input signal VCS inputted from the input signal analysis unit 711. The signal adjustment unit 713 sends the input signal VCSA to the pixel control circuit 72 and sends a light source control signal LCSA to the light source control unit 52. The light source control signal LCSA is, for example, a signal containing information on a light amount of the light source unit 50, which is set according to an input gradation value to the pixel PIX.

The pixel control circuit 72 generates a horizontal drive signal HDS and a vertical drive signal VDS based on the input signal VCSA. For example, in this embodiment, the plurality of pixels PIX are driven in a field sequential manner. Therefore, in the pixel control circuit 72, the horizontal drive signal HDS and the vertical drive signal VDS are generated for each color that the light source unit 50 can emit.

The gate drive circuit 73 sequentially selects the gate lines GL (in other words, signal lines) of the transparent display panel within one vertical scanning period based on the horizontal drive signal HDS. The order of selection of the gate lines GL is arbitrary. As shown in FIG. 3, the plurality of gate lines GL extend in the X direction (x direction) and are arranged along the Z direction (y direction).

The source drive circuit 74 supplies a gradation signal corresponding to an output gradation value of each pixel PIX to each source line SL (in other words, signal wiring) of the transparent display panel within one horizontal scanning period based on the vertical drive signal VDS. As shown in FIG. 3, the plurality of source lines SL extend in the Z direction (y direction) and are arranged along the X direction (x direction). One pixel PIX is formed at each intersection between the gate line GL and the source line SL.

A switching element Tr is formed at each of portions with which the gate line GL and the source line SL intersect. The plurality of gate lines GL and the plurality of source lines SL correspond to a plurality of signal wirings that transmit the drive signals for driving the liquid crystal of the liquid crystal layer LQL in FIG. 4.

For example, a thin film transistor is used as the switching element Tr. A type of thin film transistor is not particularly limited. One of a source electrode and a drain electrode of the switching element Tr is connected to the source line SL, the gate electrode is connected to the gate line GL, and the other of the source electrode and the drain electrode is connected to one end of capacitor of a polymer dispersed liquid crystal LC (corresponding to the liquid crystal of the liquid crystal layer LQL in FIG. 4). The one end of the capacitor of the polymer dispersed liquid crystal LC is connected to the switching element Tr via the pixel electrode PE, and the other end is connected to a common potential wiring CML via a common electrode CE. Further, a storage capacitor HC is generated between the pixel electrode PE and a storage capacitor electrode electrically connected to the common potential wiring CML. The common potential wiring CML is supplied from a common potential drive circuit 75. A wiring path connected to the common electrode CE in FIG. 5 is formed, for example, on the first substrate 11 in FIG. 3. In FIG. 5, the wiring formed on the first substrate 11 is illustrated by a dotted line.

In the configuration example shown in FIG. 5, the drive circuit 70 includes a light source control unit 52. As a modification example, the light source unit 50 and the light source control unit 52 may be provided separately from the drive circuit 70. As described above, when the light source unit 50 is mounted on a light source substrate different from the second substrate 12, the light source control unit 52 may be formed on the light source substrate, or may be formed on an electronic component mounted on the light source substrate.

### [Use of Transparent Display]

Using the transparent display 1 as described above, for example, in a space such as a store, communication and the like via the display image in the display region DA of the screen 20 can be made face-to-face between the person (user U1 in FIG. 1) on the front side of the first surface s1 and the person on the back side of the second surface s2. Alternatively, for example, if the person (user U1 in FIG. 1) only on the first surface s1 side is present, the above person can view the display image on the screen 20 by superimposing it on the background, or use the transparent display 1 at a predetermined user interface.

A microphone, a voice recognition system, a language translation system, and the like may be connected to or built into the transparent display 1. In that case, the transparent display 1 can input, for example, voice of the user on the back side, convert it into character information, and display a character video image corresponding to the character information on the screen 20. The person on the front side can visually recognize the character video image displayed on the screen 20 while viewing the person on the back side passing through the screen 20. The transparent display 1 may be provided with a transcription function as described above.

Furthermore, the transparent display 1 may use the voice recognition system or the like to convert the voice inputted by the user into a predetermined command or the like, and execute/control the functions of the transparent display 1 by using the command or the like.

Further, a speaker, a voice synthesis system, and the like may be connected to or built into the transparent display 1. In that case, the transparent display 1 can convert, for example, the character information corresponding to the character video image displayed on the screen 20 into audio and can output it from the speaker. This allows the user to make the communication and the like while listening to the character video image on the screen 20 as well as the audio.

[controller]

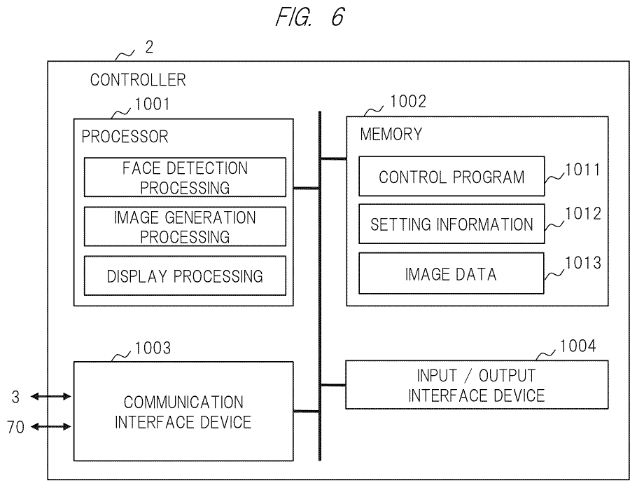

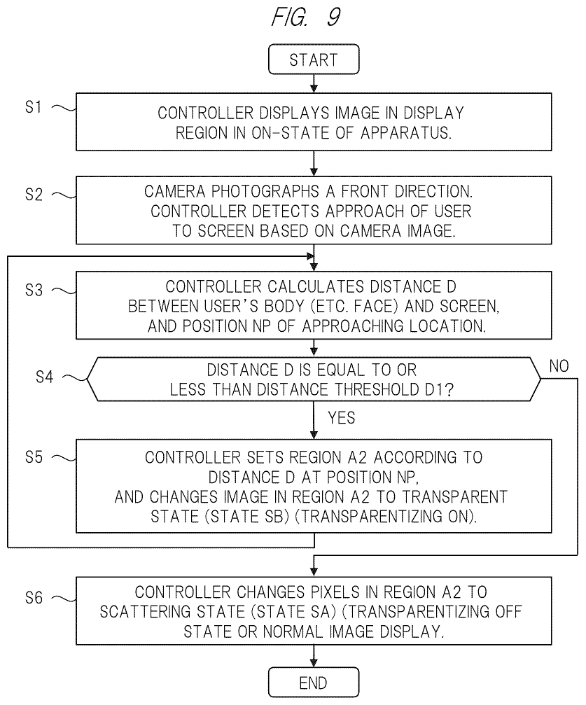

FIG. 6 is a functional block diagram showing a configuration example of the controller 2, which is a control device. The controller 2 in FIG. 6 includes a processor 1001, a memory 1002, a communication interface device 1003, an input/output interface device 1004, and the like, which are interconnected via a bus or the like. The processor 1001 executes a processing according to control program 1011. Consequently, predetermined functions, processing units, and the like are realized. The functions and the processing units implemented by the processor 1001 include a face detection processing, an image generation processing, a display processing, and the like. Details of these will be shown in FIG. 9 and the like which will be described later. The memory 1002 stores a control program 1011, setting information 1012, image data 1013, and other data and information related to processings. The control program 1011 is a computer program that implements functions and the like. The setting information 1012 is system setting information and user setting information. The image data 1013 is data for displaying images and video images on the screen 20. The communication interface device 1003 is connected to the camera 3, the drive circuit 70 of the main body 10, an external device, and the like, and performs a communication processing by using a predetermined communication interface. The input devices and the output devices can be connected to the input/output interface device 1004.

### [Transparentizing Control]

Next, transparentizing control will be described as one of the features of the transparent display 1 of the first embodiment shown in FIG. 1 and the like. Based on the control of the controller 2, the transparent display 1 in FIG. 1 has a function of transparentizing the region A2 corresponding to the location A1 where the user U1 approaches in displaying the image (a dotted pattern region in FIG. 1) on the screen 20

In the transparent display 1, a mechanism for changing the degree of transparency of the image in the display region DA of the screen 20, which is necessary to realize such a transparentizing control function, that is, a mechanism for changing the degree of transparency of each pixel in the liquid crystal layer LQL that is the display layer 13 can be applied by known techniques as shown in FIGS. 3 to 5.

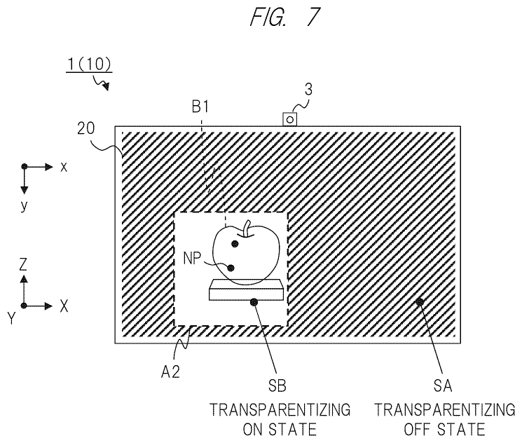

As an explanatory diagram of the transparentizing control, FIG. 7 shows a schematic configuration diagram, on the X-Z plane (x-y plane), a case of planarly viewing the screen 20 in the Y direction from the user U1 on the first surface s1 side. As shown in FIG. 1, when a body of the user U1, for example, a face UF approaches the first surface s1 side of the screen 20, peculiarly the controller 2 of the transparent display 1 uses the camera 3 to detect the approach. In addition, peculiarly the controller 2 of the transparent display 1 detects the distance D between the user U1 and the screen 20 based on the image of the camera 3. In FIG. 1, the distance D is a distance between the face UF and the position NP.

As shown in FIGS. 1 and 7, the controller 2 of the transparent display 1 controls a pixel state about the region A2 selected and set so as correspond to the location A1 and the position NP that the user U1 approaches, thereby controlling the transparentizing. Specifically, the controller 2 changes the pixel state about the region A2 from a normal image display state (state SA in FIG. 7) to a transparent state (state SB in FIG. 7) of making the image transparent and passing the background through it. In FIG. 7, the region A2 is in the state SB (indicated by a white region), and a region other than the region A2 is in the state SA (indicated by diagonal line patterns). In other words, the state SA is a transparentizing off state, and corresponds to a scattering state as the liquid crystal of the liquid crystal layer LQL in FIG. 4, that is, a state of mainly emitting the emission light L2. In other words, the state SB is a transparentizing on state, and corresponds to a transparent state as the liquid crystal of the liquid crystal layer LQL in FIG. 4, that is, a state of mainly passing through the background light L3. If it is assumed that the state SA is first transparency and the state SB is second transparency, the state SB is a state with higher transparency than the state SA (second transparency>first transparency).

In the example of FIG. 7, when the distance D becomes less than or equal to a certain distance, the region A2 is made the state SB of the transparentizing. Consequently, from the viewpoint of the user U1, the object B1 in the background can be clearly visually recognized via the region A2. Further, an example of the transparentizing control is to control on/off of the transparentizing by using binary values of the state SA (transparentizing off state) and the state SB (transparentizing on state). In a case of this control, the state SB of transparentizing the region A2 is set to the maximum transparency possible based on hardware, for example. The present embodiment is not limiting to this, the transparency of the state SB in the region A2 may be a predetermined transparency set within a possible range. Further, as will be described later, as another example of the transparentizing control, the transparency of the state SB in the region A2 may be controlled as multivalued transparency that is continuously varied according to a size of the distance D.

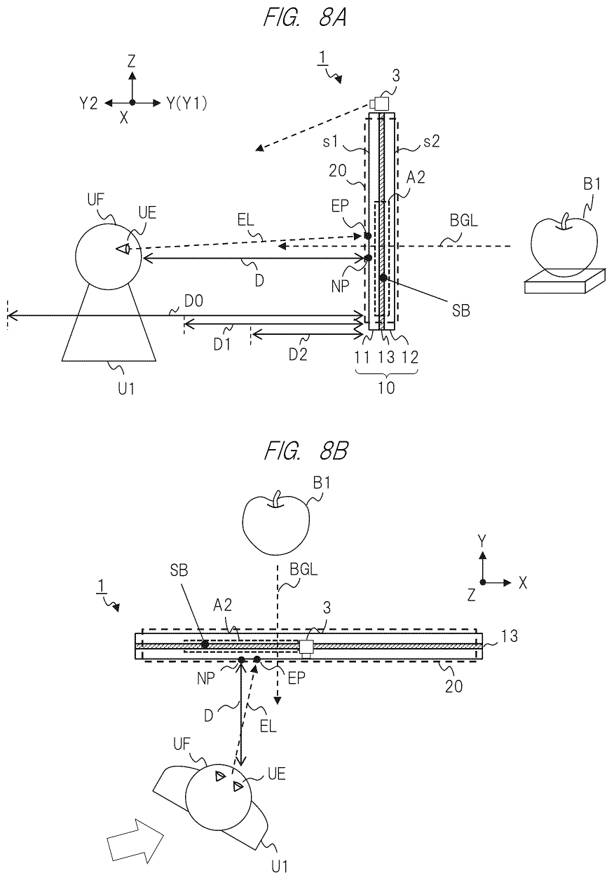

FIGS. 8A and 8B are explanatory diagrams of the distance D and the like, which corresponds to FIG. 7. FIG. 8A is a schematic explanatory diagram of the transparent display 1 viewed from the side in the Y-Z plane. FIG. 8B is a schematic explanatory diagram of the transparent display 1 viewed from above in the X-Y plane. The examples of FIGS. 7, 8A, and 8B show a case of viewing the display image and the object B1 in the background via the region A2 from the viewpoint (eye UE) of the user U1 on the first surface s1, which is the front surface, with respect to the screen 20 of the main body 10 in the Y direction. In an example of FIG. 8A, it is assumed that heights of the face UF of the user, the region A2, and the object B1 are approximately the same. In an example of FIG. 8B, the user U1 who approaches the screen 20 of the main body 10 from the first surface s1 side makes the face UF slightly oblique to the screen 20, and the visual line EL directed toward the object B1 and slightly oblique to the screen 20.

The camera 3 is installed at the main body 10 or at a predetermined position near the main body 10, in this example, at a center position of an upper side. The camera 3 photographs the front direction (direction Y2) from the first surface s1 side. The controller 2 detects, for example, a person's face, for example, the face UF of the user U1 based on the image of the camera 3, and detects that the face UF has approached the screen 20 to a certain extent. For example, the controller 2 may determine that the user U1 has approached the screen 20 when the face UF is recognized and extracted from the camera image. Alternatively, the controller 2 calculates, for example, the distance D between the face UF and the screen 20 (for example, position NP), and when the distance D becomes less than or equal to a predetermined distance threshold (for example, DO in FIG. 8A), the controller 2 may determine that the user U1 has approached the screen 20.

FIGS. 7, 8A, and 8B show a case where the distance D is calculated by using a perpendicular line to the screen 20. An intersecting point at which the perpendicular line is drawn from the face UF or eye UE to the screen 20 is the position NP. In one example, the controller 2 uses this position NP to set the region A2.

When the controller 2 determines that the user U1 has approached the screen 20, it sets the region A2 corresponding to the approaching position NP. For example, as shown in FIGS. 7, 8A, and 8B, the region A2 is set with a predetermined size or a size according to the distance D centering on the position NP. Then, the controller 2 controls the region A2 so as to change from the state SA, which is the display state/transparentizing off state, to the state SB, which is the transparentizing on state, as shown in FIG. 7. When viewing the region A2 from the eyes UE of the user U1, the original display image becomes a state of being not visible or being difficult to view due to the transparentizing. And yet in this case, the background light BGL from the second surface s2 side is transmitted forward via the region A2, so that the object B1 in the background is easily visible.

Furthermore, as will be described later, when performing the transparentizing control by using the visual line EL of the user U1, the transparent display 1 uses the camera 3 (or an eye tracking device) to detect the visual line EL of the user U1 approaching the screen 20 and detect the gaze point EP that is a position where the visual line EL intersects with the screen 20. Then, the controller 2 uses the distance D and the gaze point EP to set the region A2 corresponding to the gaze point EP, and controls the transparentizing. For example, the region A2 centering on the gaze point EP is set.

In the examples of FIGS. 7, 8A, and 8B, the distance D between the face UF of the user U1 and the position NP in the screen 20 is used, but the distance D is not limited to this and may use a distance between a part of the body of the user U1 and the screen 20. In a modification example, a distance from a position of the camera 3 to a part of the face UF or the like of the user U1 or a distance from a predetermined position in the screen 20, for example, from a center point to the part of the face UF or the like of the user U1 may be also used.

### [Processing Flow]

FIG. 9 shows a basic processing flow example by the controller 2 in the first embodiment. Flows in FIG. 9 include steps S1 to S6.

In step S1, the controller 2 displays the image in the display region DA of the screen 20 while the device of the transparent display 1 is in an on state. This image is an arbitrary image according to use application. In one example, this image may be an environmental video image, a video image of an advertisement at a store, or a video image of procedure guide at a government office.

In step S2, the camera 3 transmits to the controller 2 an image photographing the front direction with respect to the first surface s1. The controller 2 detects that the user U1 approaches the first surface s1 of the screen 20 based on a processing of the image of the camera 3. This detection of the approach may be detection of the face UF in the image of the camera 3, or detection of entering within a predetermined distance range from the screen 20.

In step S3, the controller 2 calculates, for the user U1 who has approached the screen 20, the distance D between the body of the user U1 (for example, the face UF) and the screen 20, and the position NP of the approaching location, as described above.

In step S4, the controller 2 determines whether the distance D has become equal to or less than a predetermined distance threshold D1. If D≤D1 (YES), the processing proceeds to step S5 and if D>D1 (NO), the processing proceeds to step S6.

Note that when detecting the approach in step S2, the determination may be made by using the distance D. For example, when the distance D becomes less than or equal to a predetermined distance threshold D0 (D0>D1), the controller may determine the approach. FIG. 8A shows an example of distance thresholds D0, D1, and D2 (D0>D1>D2).

In step S5, the controller 2 sets the region A2 at the position NP of the screen 20 according to the distance D at that time, and controls a state of the pixels of the display layer 13 (liquid crystal layer LQL) from the scattering state to the transparent state so as to change the region A2 to the transparentizing on state SB as shown in FIG. 7. After step S5, the processing returns to step S3 and the same processing is repeated.

In step S6, the controller 2 remains maintaining the state SA if the distance D is not equal to or less than the distance threshold D1. If the distance D becomes less than or equal to the distance threshold D1 and then returns to a state where it is larger than the distance threshold D1, the controller 2 changes the state SB of the region A2 to the state SA, thereby turning off the transparentizing. After step S6, this flow ends, and the processing is similarly repeated from the beginning.

### [Transparentizing Control]

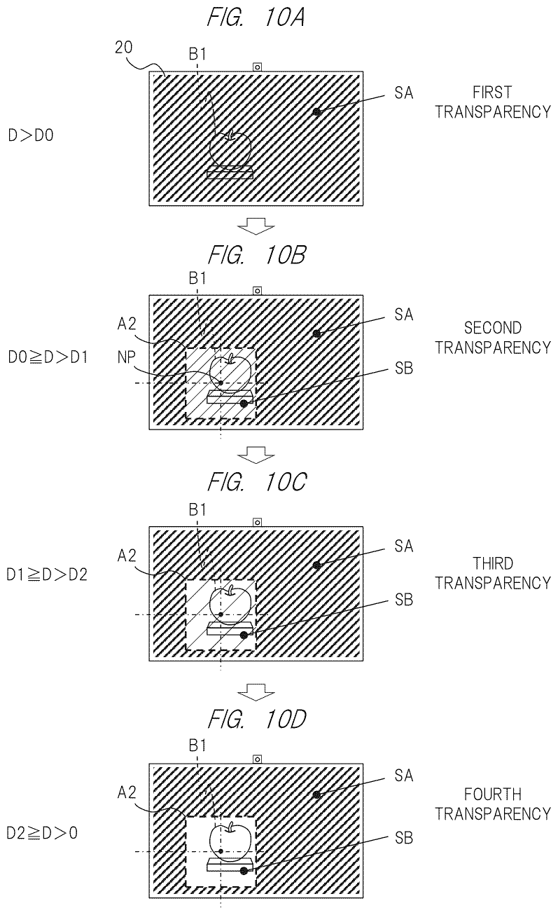

FIGS. 10A to 10D are explanatory diagrams of, as one example of the transparentizing control in the first embodiment, a case in which transparency of a location where the user U1 approaches the screen 20 is continuously or stepwise variably controlled according to the distance D. FIGS. 10A to 10D show a case where the screen 20 is planarly viewed in the Y direction from the first surface s1 side which is the front surface. FIGS. 10A to 10D show a case of setting the region A2 at the position NP of the location at which the user U1 approaches and further controlling the transparency stepwise according to the distance D.

FIG. 10A shows a state where the distance D is larger than the distance threshold D0 (D>D0). This state is a state in which the user U1 has not yet approached the screen 20, the entire region of the screen 20 is in the state SA which is a normal image display state, and the region A2 is not set. The transparency in the state SA is a first transparency, which is a relatively low transparency that gives priority to the image display. In this state SA, the object B1 in the background is difficult to see.

FIG. 10B shows a state in which the user U1 further approaches the screen 20 and the distance D is less than or equal to the distance threshold D0 and larger than the first distance threshold D1 (D0≥D>D1). In this state, the controller 2 sets the region A2 according to the distance D and the position NP, and changes the state of the region A2 from the state SA to the state SB. Further, the controller 2 sets the transparency in the state SB to a second transparency. The second transparency is a predetermined transparency higher than the first transparency. In this state, it becomes easier to see the background object B1 to some extent via the region A2 from the viewpoint of the user U1. Note that the second transparency in FIGS. 10A to 10D is different from the second transparency in FIG. 7.

FIG. 10C shows a state in which the user U1 further approaches the screen 20 and the distance D is larger than the second distance threshold D2 less than or equal to the first distance threshold D1 (D1≥D>D2). In this state, the controller 2 further changes the transparency at the state SB of the region A2 to a third transparency. The third transparency is a predetermined transparency higher than the second transparency. In this state, the background object B1 becomes even more visible from the viewpoint of the user U1 via the region A2.

FIG. 10D shows a state in which the user U1 further approaches the screen 20 and the distance D becomes equal to or less than the second distance threshold D2 (D2≥D>0). In this state, the controller 2 further changes the transparency at the state SB of the region A2 to a fourth transparency. The fourth transparency is the maximum transparency higher than the third transparency, and is a transparency that gives priority to the visibility of the background. In this state, the background object B1 is clearly visible from the viewpoint of the user U1 via the region A2.

The example of the transparentizing control described above is a case of the control of making the transparency of the region A2 stepwise varied in four values from the first transparency to the fourth transparency according to the distance D. The present embodiment is not limited to this, and the control of making the transparency of the region A2 continuously varied in multiple values according to the size of the distance D is possible.

Although the above example shows a case where the position NP is constant and a case where the size/area of the region A2 is constant, the present embodiment is not limited to this.

### [Control of Transparent Area]

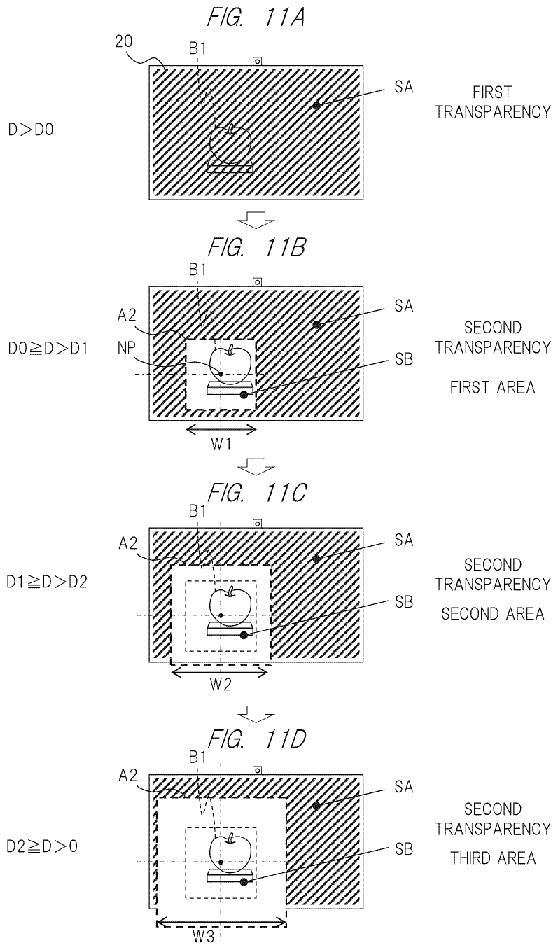

FIGS. 11A to 11D are explanatory diagrams, as an example of transparency control in the first embodiment, a case where a transparent area of the region A2 at the location where the user U1 approaches the screen 20 is continuously or stepwise variable controlled according to the distance D. FIGS. 11A to 11D show a case of planarly viewing the screen 20 in the Y direction from the first surface s1 side, which is the front surface. FIGS. 11A to 11D show a case where the region A2 is set at the position NP of the location which the user U1 approaches, and a case of further controlling stepwise a transparentizing area according to the distance D.

FIG. 11A is similar to FIG. 10A, and shows a state where the distance D is larger than the distance threshold D0 (D>D0). The entire region of the screen 20 is in the state SA and has a predetermined first transparency.

FIG. 11B shows a state where the user U1 further approaches the screen 20 and the distance D is less than or equal to the distance threshold D0 and larger than the first distance threshold D1 (D0≥D>D1). In this state, the controller 2 sets the region A2 according to the distance D and the position NP, and changes the state of the region A2 from the state SA to the state SB. The state SB has a predetermined second transparency (for example, the maximum transparency) higher than the first transparency. Further, the controller 2 sets a first size as the size of the region A2, and sets a first area as the area of the region A2. In this example, the region A2 is rectangular and has a width W1 as the size of the region A2. In this state, the object B1 in the background becomes easier to see to some extent from the viewpoint of the user U1 via the transparentized region A2.

FIG. 11C shows a state where the user U1 further approaches the screen 20 and the distance D is less than or equal to the first distance threshold D1 and larger than the second distance threshold D2 (D1≥D>D2). In this state, the controller 2 changes the size of the region A2 to a second size, and changes its area to a second area. The present embodiment has a width w2 as the size of the region A2. In this state, the object B1 in the background becomes more visible via the enlarged region A2 from the viewpoint of the user U1.

FIG. 11D shows a state where the user U1 further approaches the screen 20 and the distance D becomes less than or equal to the second distance threshold D2 (D2≥D>0). In this state, the controller 2 changes the size of the region A2 to a third size and changes the area to a third area. The region A2 has a width W3. In this example, the width W3 is larger than the width W2, and the third area is larger than the second area. In this state, the background object B1 is clearly visible from the viewpoint of the user U1 via the enlarged region A2.

The example of the transparentizing control described above is a case of the control in which the size and the area of the region A2 are varied stepwise according to the distance D. The present embodiment is not limited to this, and it is possible to control the size and the area of the region A2 so as to be continuously varied according to the size of the distance D.

Although the above example shows a case where the position NP is constant and a case where the transparency at the state SB of the region A2 is constant, the present embodiment is not limited to this. Control that combines the control of the transparency shown in FIGS. 10A to 10D and the control of the transparent area shown in FIGS. 11A to 11D is also possible. For example, as the distance D becomes smaller, such control and the like as to make the transparency of the region A2 higher and make the area thereof larger is possible. Further, as a modification example, the transparent display 1 may be controlled, for example, so that as the distance D is closer, the transparent area of the region A2 is made smaller.

### [Motion Tracking]

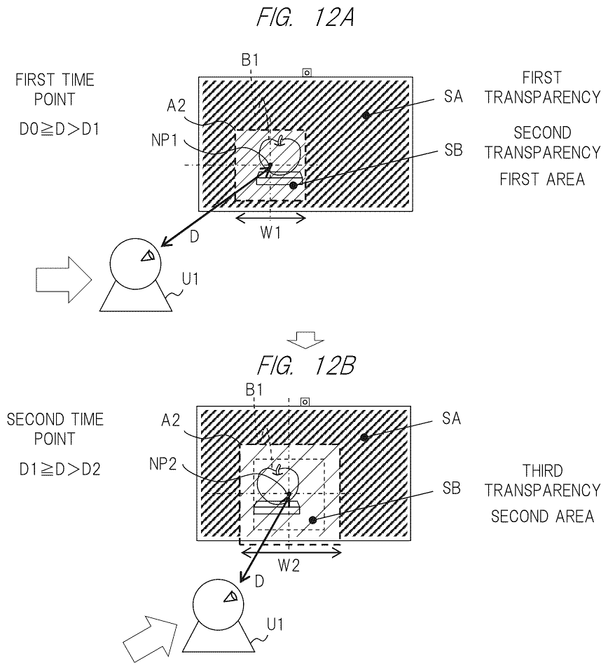

FIGS. 12A and 12B show examples of a case where transparency control shown in FIGS. 10A to 10D and transparent area control shown in FIGS. 11A to 11D are performed simultaneously and a case where the control is performed according to fluctuation of the position NP tailored to the motion of the user U1. FIG. 12A shows a state of setting the region A2 at the position NP1 corresponding to a first time point when the user U1 approaches the first surface s1 of the screen 20 and the distance D becomes equal to or less than the distance threshold D0. The region A2 changes from the first transparency of the state SA to the second transparency of the state SB, and has the first size and the first area set based on the width W1.

FIG. 12B shows a state of setting the region A2 at the position NP2 corresponding to a second time point when the user U1 moves from the state of FIG. 12A and the distance D becomes equal to or less than the distance threshold D1. The region A2 changes to the third transparency in the state SB, and has the second size and the second area set based on the width W2. For example, the position NP2 has moved to right from the position NP1. In this state, from the viewpoint of the user U1, the background object B1 is more visible via the enlarged region A2 by the transparency increased.

### [Visual Line Detection]

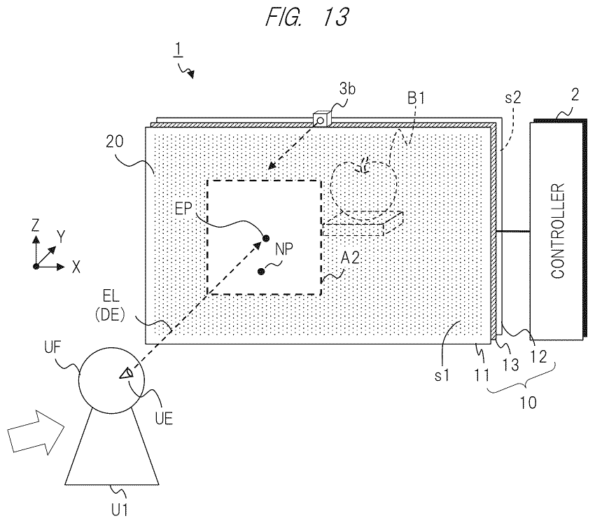

FIG. 13 shows an example in which the same transparency control as above is performed by using the visual line EL of the user U1 and the gaze point EP. In this example, the above-mentioned position NP is not used. An eye tracking device 3b is installed on the transparent display 1. When the user U1 approaches the screen 20, the controller 3 uses the eye tracking device 3b to detect the visual line EL of the user U1 and detect the gaze point EP where the visual line EL intersects with the screen 20. Further, the controller 2 calculates a distance DE corresponding to the visual line EL, for example, the distance between the eye UE and the gaze point EP. The controller 2 uses the gaze point EP and the distance DE to set the region A2. For example, the region A2 is set so as to be centered on the gaze point EP, and the transparency and the area of the region A2 are set. The controller 2 variably controls the transparency and the area of the region A2 in the same way as described above according to a change in the distance DE.

In a control example of FIG. 13, visual line detection is required, but the transparentizing region A2 can be set so as to be tailored to the visual line EL of the user U1 and the gaze point EP, and an effect of making it easier to see the object B1 and the like in the background beyond the visual line EL is obtained. Furthermore, in the first embodiment, a case of detecting that the user U1 (in other words, a moving object) moves and the user U1 approaches the screen 20 has been described. However, the present embodiment is not limited thereto and, as a modification example, for example, even if the user U1 remains stationary and is present in front of the screen 20, the same control is possible according to the distance D and the like.

### [Effect and the Like (1)]

As described above, according to the first embodiment, the transparent display 1 can be used in a new way, and communication, convenience, and the like can be improved. In the first embodiment, the predetermined image is normally displayed on the screen 20, and when the user U1 approaches the screen 20, the background can be easily visually recognized by the transparentizing control. For example, in the case of a store window glass or the like, an advertisement or the like is normally displayed on the screen 20, and when a customer approaches the screen 20, the transparentizing makes it easier to visually recognize products and the like. For example, in the case of a government office counter or the like, procedure guidance and the like are normally displayed on the screen 20, and when the customer approaches the screen 20, the transparentizing makes it easier to visually recognize staff members and other people. Note that regarding the several transparentizing control examples described above, which control is applied may be fixedly set in the system of the transparent display 1 in advance, or may be selected by user settings.

### Second Embodiment

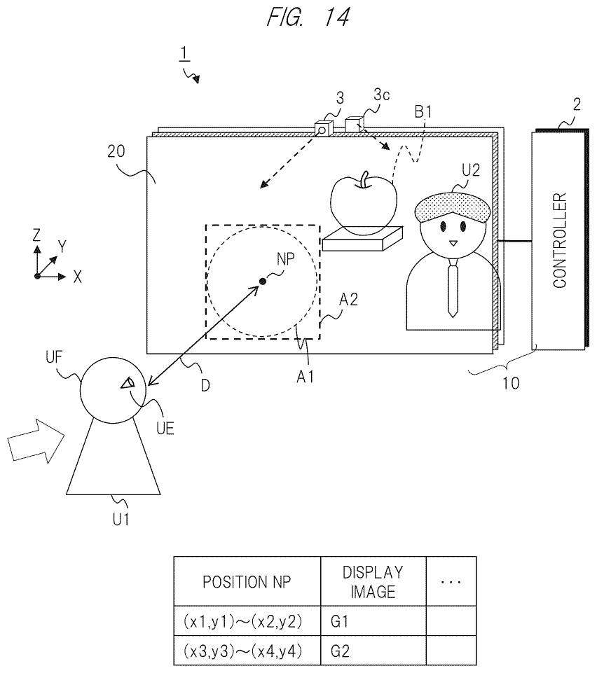

A transparent display apparatus according to a second embodiment will be described by using FIG. 14 and subsequent figures. The basic configuration of the second embodiment and the like is the same as and common to the first embodiment. Hereinafter, components different from the first embodiment in the second embodiment and the like will be mainly explained. The transparent display apparatus of the second embodiment is the transparent display 1 shown in FIG. 14 and the like.

In the second embodiment, the transparent display 1 adds and displays an image(s) at the location where the user U1 approaches the screen 20. In particular, the transparent display 1 adds and displays the image associated according to the position NP that the user U1 approaches. In the second embodiment, a case where control is performed by using the distance D and the position NP similarly to the first embodiment will be explained, but the present embodiment is not limited to this.

FIG. 14 is a schematic explanatory diagram showing control by the transparent display 1 in the second embodiment. In this example, the transparent display 1 is installed at the counter of the store, the government office, or the like, and the user U1 such as a customer or resident is present on the first surface s1 side. A person U2 such as a salesperson or a staff member of the store or government office is present on the second surface s2 side. For example, it is assumed that the salesperson guides or sells the object B1 such as a product to the user U1 at the store.

On the transparent display 1, the camera 3 is installed toward the first surface s1, and a camera 3c is installed toward the second surface s2. The camera 3 photographs a space on the first surface s1 side, and the camera 3c photographs a space on the second surface s2 side. The camera 3 and the camera 3c are sensor devices similar to those described above, and the eye tracking device may also be applied.

The transparent display 1 displays a predetermined image on the screen 20 based on the control by the controller 2. In a state of FIG. 14, no image is initially displayed on the screen 20 (in other words, a state of maximum transparency). However, the present embodiment is not limited thereto, and the predetermined image may be displayed from initially.

Similar to the first embodiment, when detecting that the user U1 approaches the first surface s1 of the screen 20, the transparent display 1 sets the region A2 for control according to the distance D from the user U1 and the position NP of the approaching point A1. The control of the region A2 by the second embodiment is different from the control of the region A2 by the first embodiment. The controller 2 adds and displays an image in the region A2 according to the position NP in the screen 20. If no image is displayed in the region A2 before the region A2 is set, only the image to be added is displayed. If the image is already displayed in the region A2 before the region A2 is set, the added image is displayed so as be superimposed on that image.

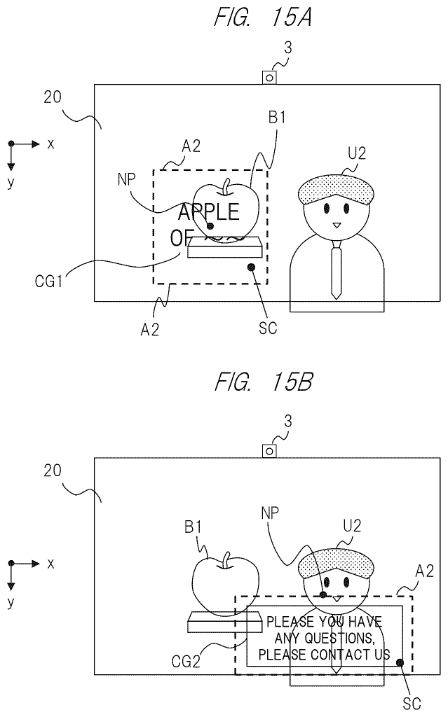

FIGS. 15A and 15B show examples in which an image is added and displayed in the region A2 of the screen 20 following FIG. 14. In an example of FIG. 15A, the user U1 is looking at the object B1 in the background, and the position NP is near the object B1. For example, when the distance D becomes less than or equal to a predetermined threshold, the controller 2 sets the region A2 centered on the position NP and sets the state of the region A2 to a predetermined state SC. In this example, the state SC corresponds to a display state (scattering state) for displaying the image as a state of the liquid crystal and the pixel PIX in the liquid crystal layer LQL (FIG. 4). The transparency at the state SC is a predetermined transparency, and, in the examples of FIGS. 15A and 15B, is such transparency that the object B1 and the like in the background can visually be recognized to some extent.

Then, the controller 2 adds and displays the image associated according to the position NP in the region A2. As shown in a lower portion of FIG. 14, a display image corresponding to the position coordinates (x, y) of the position NP may be set in advance in data such as a table. For example, it is set that the display image G1 is displayed when the position coordinates of the position NP are within a range of (x1, y1) to (x2, y2). In the example of FIG. 15A, the controller 2 controls a character image CG1 to be displayed in the region A2 as an additional image to be displayed. The character image CG1 is, for example, a character image “apple of ˜ ˜ ˜” that describes the object B1 displayed correspondingly to the position NP. The description includes, for example, a product name, a production area/manufacturer, and the like. The user U1 can obtain information about the object B1 such as a product of interest by viewing the character image CG1.

FIG. 15B is another example. The user U1 is looking at a person U2 such as a salesperson, and the position NP is near the person U2. For example, when the distance D becomes less than or equal to a predetermined threshold, the controller 2 sets the region A2 at the position NP and puts the region A2 in the state SC. For example, the region A2 is set at a lower-side position with respect to the position NP. The controller 2 controls a character image CG2 so as to be displayed in the region A2 as an image to be added and displayed. The character image CG2 is, for example, the character image “If you have any questions, please contact us” associated with the person U2. In this example, this character image is a message or the like from the person U2 such as a salesperson to the customer. By viewing this character image CG2, the user U1 can communicate more smoothly with the person U2 such as a salesperson and can, for example, consult and the like about the product.

In the second embodiment, when setting the region A2 for the position NP that the user U1 has approached, not only the additional image of the region A2 but also detailed positions, shapes, areas, and the like may be controlled. Control contents associated for each position NP within the screen 20 may be different. In addition, also in the second embodiment, as in the first embodiment, various modification examples such as control using the visual line EL are possible.

Although the above control example is a case where the additional display image is made the character image, the present embodiment is not limited to this. The additional display image may be any image, for example, an icon, an animation, or the like.

Further, although the above control example is a case where the additional display image is defined according to the positional coordinates of the position NP within the screen 20, the present embodiment is not limited to this. For example, when the person or object on the second surface s2 side moves, the additional display image may be defined so as be tailored to the position of the moving person or object. For example, in FIGS. 14, 15A, and 15B, when the person U2 moves, the controller 2 detects the position of the person U2 by using the camera 3c on the back side. When the position NP that the user U1 on the front side approaches is near the position of the person U2, the controller 2 adds and displays the image set in association with the person U2 in the region A2.

### [Effect and the Like (2)]

As described above, according to the second embodiment, the transparent display 1 can be used in a new way, and communication, convenience, and the like can be improved. In the second embodiment, when the user U1 approaches the screen 20, the image corresponding to the approaching position can be added and displayed. By viewing the additional display image, the user U1 can obtain information about the objects and the persons present from the front side to the back side.

### First Modification Example of Second Embodiment

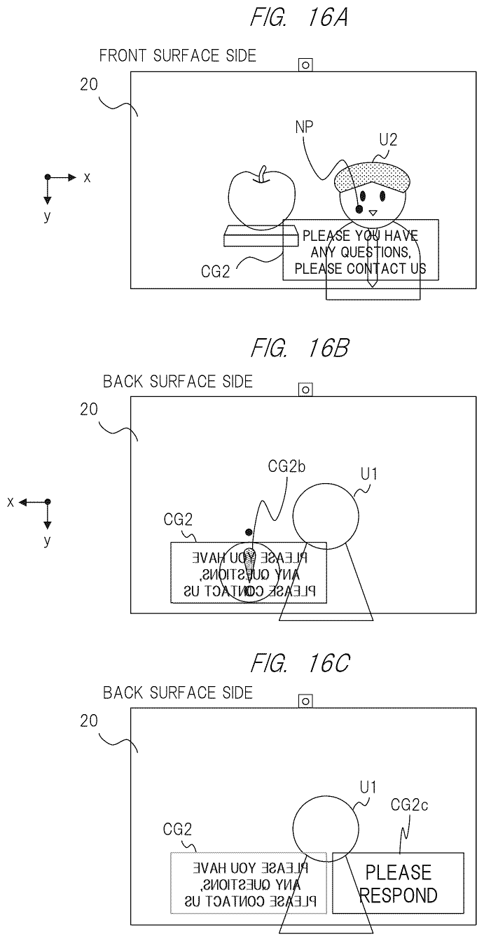

FIGS. 16A to 16C show a first modification example of the second embodiment. This first modification example further makes collaboration to the additional display image on the back side from the additional display image on the front side in addition to the controls shown in FIGS. 15A and 15B.

FIG. 16A is a schematic diagram of the screen 20 viewed from the first surface s1 side and, for example, similarly to FIG. 15B, shows a case where after the character image CG2 associated with the person U2 is displayed, the user U1 interacts with the character image CG2. For example, the interaction with the character image CG2 include a case where the user U1 remains near the position NP corresponding to the character image CG2 for a certain period of time or longer, a case where the user U1 gazes at the character image CG2 for a certain period of time or longer, or the like. The controller 2 detects such interactions by using the camera 3 or the like.

When the controller 2 detects the interaction with the character image CG2, the controller 2 controls another image associated with the character image CG2 and directed toward the second surface s2 side, which is the back surface, in other words, the additional display image at a second stage so as to be added and displayed. FIG. 16B is a schematic diagram when the screen 20 is viewed from the person U2 on the second surface s2 side. The character image CG2 becomes a state where the characters are inverted. The controller 2 adds and displays an image CG2b for notifying the person U2 to the character image CG2. In this example, the image CG2b is an exclamation mark icon, and is image information of a notification for conveying, to the person U2 on the back side, the presence of the interaction from the user U1 on the front side.

In an example of FIG. 16B, the image CG2b is displayed so as to be superimposed on a back side of the character image CG2 at the position NP, but the present embodiment is not limited to this. In another example, only the image CG2b may be displayed at the position NP after the character image CG2 is erased.

FIG. 16C shows a different example from that of FIG. 16B. When the controller 2 detects the interaction with the character image CG2, the controller 2 adds and displays an image CG2c for notifying the person U2 to and at a predetermined position other than the position NP of the character image CG2. In this example, the image CG2c is a character image “Please respond” of the notification to the person U2. This image CG2c is displayed as an image that can be easily visually recognized by the person U2 on the back surface side. By viewing this image CG2c, the person U2 such as a salesperson can have a relay with a response to the customer on the front surface side.

### Second Modification Example of Second Embodiment

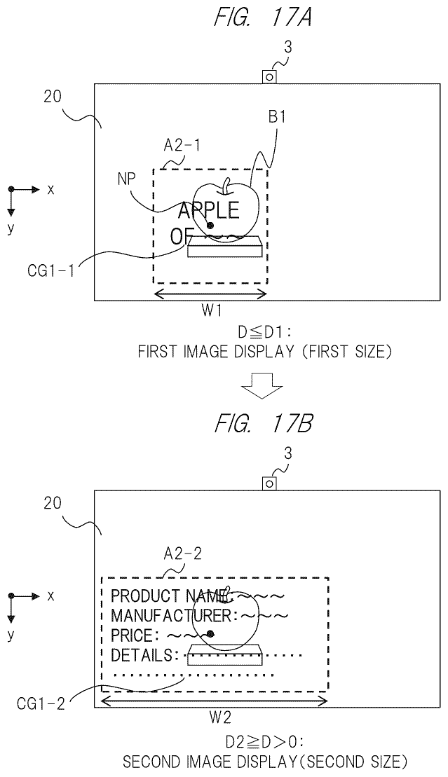

FIGS. 17A and 17B show a second modification example of the second embodiment. In addition to the controls shown in FIGS. 14, 15A, and 15B, this second modification example performs the control of the additional display images stepwise. FIG. 17A shows a case where there is the object B1 in the background in a plan view of the first surface s1 of the screen 20. When the user U1 approaches the screen 20, the controller 2 sets the region A2 according to the distance D and the position NP. In this example, when the distance D becomes less than or equal to the distance threshold D1 (D1≥D>D2), the controller 2 first sets a region A2-1 with the first size (for example, width W1) at the position NP and adds and displays a character image CG1-1 (for example, character image “apple of ˜ ˜ ˜”) in the region A2-1.

Next, FIG. 17B is a state in which the user U1 is closer to the screen 20 from the state in FIG. 17A and the distance D has become equal to or less than the distance threshold D2 (D2≥D>0). In this case, the controller 2 sets a region A2-2 with the second size (for example, width W2) at the position NP, and adds and displays a character image CG1-2 instead of the character image CG1-1 in the region A2-2. In other words, the controller 2 changes the size of the region A2 to change it to a second stage image. In this example, the width W2 of the region A2-2 is enlarged so as to become larger than the width W1 of the region A2-1. While the image CG1-1 of the first stage region A2-1 is simple information, the image CG1-2 of the second stage region A2-2 is more detailed information. The image CG1-2 is, for example, a character image of detailed information about the product corresponding to the object B1, and includes information such as product names, manufacturers/places of productions, prices, and details.

As in the above example, when adding and displaying the image according to the position NP, the contents of the image may be changed stepwise according to the distance D. Although the above example is an example of expanding the size and the area of the region A2 of the additional display image, the present embodiment is not limited to this. In another example, as the distance D becomes smaller, the size of the region A2 may be smaller. In another example, the size of the region A2 is kept constant regardless of the distance D, and as the distance D becomes smaller, detailed information may be packed therein and displayed by a reduction in a font size of the displayed character image or the like. As the distance D between the user U1 and the screen 20 becomes shorter, the user U1 easily reads the character image according to the reduction of the distance, so that reducing the character image according to the distance D is also possible as a part of the control.

### Third Embodiment

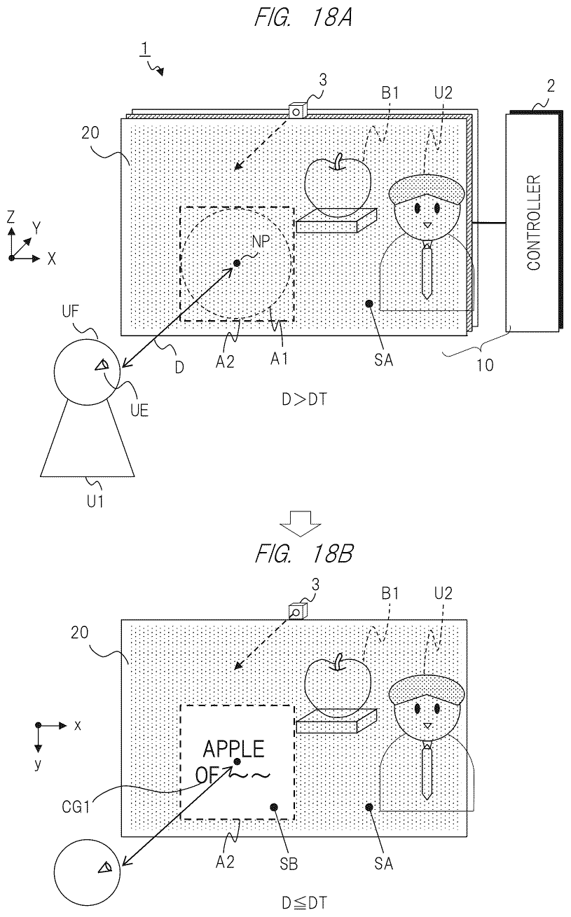

A transparent display apparatus according to a third embodiment will be described by using FIGS. 18A and 18B. the third embodiment has a configuration in which the first embodiment and the second embodiment are integrated into one. As shown in FIGS. 18A and 18B, a transparent display 1 according to the third embodiment sets a transparentizing region A2 at the position NP according to the distance D when the user U1 approaches the screen 20. Then, the transparent display 1 makes the region A2 the transparentizing on state or its transparency variable, and makes the transparent area of the region A2 variable.

FIGS. 18A and 18B show a control example in the third embodiment, and show a plan view of viewing the first surface s1 of the screen 20. When the user U1 approaches the screen 20, the controller 2 sets the region A2 at the approaching location A1 according to the distance D and the position NP. The controller 2 changes a transparentizing state of the region A2 according to the change in the distance D. It is assumed that a state in FIG. 18A is a state in which the user U1 is not very close to the screen 20 and the distance D is larger than a certain threshold DT. In this state, the controller 2 does not yet set the region A2 and does not control the transparentizing or the like. The entire region of the screen 20 is in a display state (state SA) of the normal image display.

A state shown in FIG. 18B is a case where the user U1 has moved closer to the screen 20, for example, a case where the distance D has become less than or equal to the threshold value DT. In this case, the controller 2 sets the region A2 according to the distance D and the position NP, and changes the region A2 from the state SA (first transparency) of the normal image display to the transparentizing on state SB (second transparency) At the same time, the controller 2 adds and displays the image corresponding to the position NP in the region A2. For example, the character image CG1 is added and displayed in the region A2. Consequently, the transparency of the region A2 becomes high, so that the user U1 can easily see the object B1 on the background side via the region A2. At the same time, the user U1 can visually recognize the character image CG1 displayed so as to be superimposed on the background object B1 in the region A2.

As in the above example, in the third embodiment, the user U1 can view the background side by transparentizing only a part (region A2), in which the user is interested, in the screen 20, and can obtain related information by the additional display. The user U1 does not have to worry too much about objects and persons on the background side since the image is the normal image display in the other parts.

### Fourth Embodiment

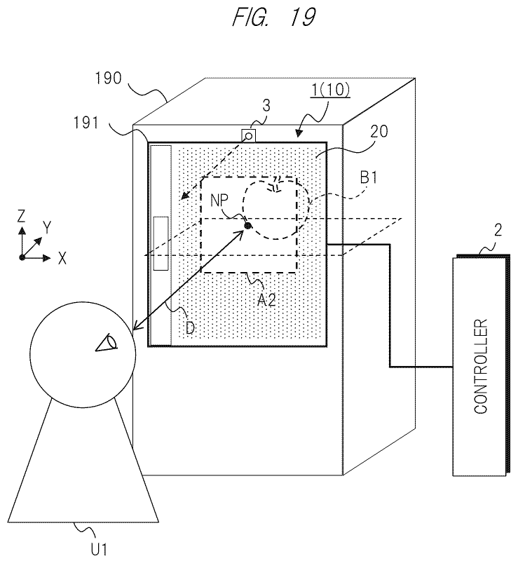

A transparent display apparatus according to a fourth embodiment will be described by using FIG. 19. The fourth embodiment shows a case where a transparent display having the same functions as those of the first embodiment is applied to a refrigerator.

FIG. 19 shows a refrigerator 190 configured so as to include the transparent display 1 of the fourth embodiment. The main body 10 of the transparent display 1 is mounted on a door 191 of the refrigerator 190. The door 191 is, for example, a sliding door mounted on a front surface of a casing of refrigerator 190. The controller 2 is connected to the main body 10. The main body 10 also includes the camera 3. The controller 2 may be integrally implemented in a control device of the refrigerator 190. Normally, the controller 2 displays a predetermined image/video image on the screen 20 of the door 191.

The controller 2 uses the camera 3 to detect whether the user U1 approaches a front surface side of the door 191. When the user U1 approaches the door 191, the controller 2 detects the distance D between the body of the user U1 and the screen 20, and the position NP of the approaching location, as in the first embodiment. Then, the controller 2 sets the region A2 at the position NP and controls the region A2 to change a current state to the transparentizing on state. For details of the control of the region A2, the various methods described in the first embodiment can be similarly applied. Use and the like of the visual line EL are possible similarly.

When the region A2 is transparentized, the object B1 inside the refrigerator 190 is visible to the user U1. This makes it possible for the user U1 to check contents of the refrigerator 190 even with the door 191 closed.

The transparent displays 1 of the second embodiment and the third embodiment can similarly be applied to the refrigerator 190 without being limited to the above example.

The following is also possible as a modification example(s) of the fourth embodiment and other embodiments. A touch sensor may be further provided on the screen 20 of the transparent display 1 (the corresponding display region DA). In particular, when only the specific user U1 uses the transparent display 1, as in the case of the refrigerator 190, that is, when there is no need to worry about physical contacts by an unspecified number of people, the touch sensor may be used.

In a case of the modification example in which the touch sensor is added and applied to the refrigerator 190 in FIG. 19, when the user U1 approaches the screen 20, the region A2 becomes the transparent state. Then, the user U1 performs a touch operation on the region A2 with a finger(S) of the user. The controller 2 controls the image display in the region A2 according to the detection of the touch operation using the touch sensor. For example, the controller 2 may control the switching of on/off of the transparentizing according to the touch operation. Alternatively, the controller 2 may control the display of the additional image according to the touch operation, as in the second embodiment.

Although the embodiments of the present disclosure have been specifically described above, the present disclosure is not limited to the above-described embodiments and can variously be modified without departing from the gist of the present disclosure. In each embodiment, components can be added, deleted, replaced, or the like except for essential components. Unless specifically limited, each component may be singular or plural. A form that combines each embodiment or modification example is also possible.

In the present embodiment, a case where the liquid crystal display device is used has been described, but as another application example, other self-luminous display devices such as organic EL devices may be applied. The functions described in the embodiments are similarly applicable to any display device including the display layer (pixel) that can transition between the transparent state and the display state. Further, the size of the screen of the display device is applicable from small to large without particular limitation.

In the present embodiment, a case where characteristic control is performed by the controller 2 of the transparent display apparatus has been described. However, the present embodiment is not limited to this, and the computer system externally connected to the controller 2 of the transparent display apparatus can also have a form in which the same characteristic control is performed.

What is claimed is:

1. A transparent display apparatus comprising:
a first substrate having a first surface;
a second substrate having a second surface opposite to the first surface;
a display layer arranged between the first substrate and the second substrate, and having pixels that can transition between a transparent state that transmits background light and a display state that displays an image;
a display region provided in a region which the first substrate, the second substrate, and the display layer overlap;
a controller controlling a state of the pixels of the display layer;
the image from a side of the first surface and a background on a side of the second surface being capable of being visually recognized; and
a sensor device for detecting a distance between a user on the first surface side in the display region and the display region, and a position corresponding to the distance in the display region,
wherein the controller uses detection information of the sensor device to control transition between the transparent state and the display state of the pixel in a partial region corresponding to the position according to the distance, thereby controlling switching of a degree of transparency.

2. The transparent display apparatus according to claim 1,
wherein the controller controls the pixels in the partial region so as to switch from the display state to the transparent state according to the distance.

3. The transparent display apparatus according to claim 1,
wherein the controller controls the degree of transparency of the pixels in the partial region so as to be changed continuously or stepwise according to the distance.

4. The transparent display apparatus according to claim 1,
wherein the controller controls an area of the partial region so as to be changed according to the distance.

5. A transparent display apparatus comprising:
a first substrate having a first surface;
a second substrate having a second surface opposite to the first surface;
a display layer arranged between the first substrate and the second substrate, and having pixels that can transition between a transparent state that transmits background light and a display state that displays an image;
a display region provided in a region which the first substrate, the second substrate, and the display layer overlap;
a controller controlling a state of the pixels of the display layer;
the image from a side of the first surface and a background on a side of the second surface being capable of visually recognized; and
a sensor device for detecting a distance between a user on the first surface side in the display region and the display region, and a position corresponding to the distance in the display region,
wherein the controller uses detection information of the sensor device to control transition between the transparent state and the display state of the pixels according to the distance, thereby controlling the image so as to be added and displayed in a partial region corresponding to the position.

6. The transparent display apparatus according to claim 5,
wherein when adding and displaying the image in the partial region, the controller controls the image so as to change from a state in which no image is displayed to a state in which the image is added and displayed.

7. The transparent display apparatus according to claim 5,
wherein when adding and displaying the image in the partial region, the controller displays an image that is set in association with the position in the display region.

8. The transparent display apparatus according to claim 5,
wherein when detecting an interaction of the user with respect to the image added and displayed to and in the partial region, the controller adds and displays an image directed toward the second surface side of the display region.

9. The transparent display apparatus according to claim 5,
wherein when adding and displaying the image to and in the partial region, the controller controls a different image stepwise so as to be added and displayed according to the distance.

10. The transparent display apparatus according to claim 1,
wherein the display layer is a liquid crystal layer, and
a light source supplying light source light to the liquid crystal layer is provided at a position that does not overlap with the display region.

11. The transparent display apparatus according to claim 5,
wherein the display layer is a liquid crystal layer, and
a light source supplying light source light to the liquid crystal layer is provided at a position that does not overlap with the display region.
